(19) United States
(12) Patent Application Publication
(10) Pub. No.: US 2009/0013569 A1
(43) Pub. Date: Jan. 15, 2009

(54) Method of competitor comparison advertising

(76) Inventor: Robert Odiema, Amherst, NH (US)

Correspondence Address: LAMBERT & ASSOCIATES, P.L.L.C., 92 STATE STREET, BOSTON, MA, 02109-2004, US

(21) Appl. No.: 11/825,792

(22) Filed: Jul. 10, 2007

(51) Int. Cl. G09F 3/00

(52) U.S. Cl. 40/299.01

(57) ABSTRACT

A method of advertising utilizing a parody of the evolution of mankind, in order to place an opponent in a lesser light or categorize an opponent as an inferior entity. Specifically the method of advertising utilizes the evolution of humankind to first exhibit an innocuous looking ape exhibiting some identifying indicia of the opposing party. By completion of the evolutionary cycle, the being depicted transforms into an intelligent human form, bearing some identifying indicia of the subject party.

### FIELD OF THE INVENTION

The present invention relates generally to the field of advertising and methods thereof specifically methods for competitor comparison advertising, wherein the opposing entity or competitor is shown to be an inferior life form when compared to the advertising entity.

### BACKGROUND

### Description of Related Art

In recent years, systems for and methods of advertising have been expanded to include a myriad of different variations in order to get the publics attention of a product. The concept of advertising between such competitors as local sports rivals is not something unique to this product. Presently, there are numerous ways of advertising products or goods involving two differing “entities” in order to allow people to express their allegiance to one “entity” over another. Below are illustrated some conventions methods of advertising.

Davis, U.S. Pat. No. (6,073,372), a rectangular cardboard insert has small pieces cut from its corners to form a flat base and four edges. The lines forming the intersections of the base with the various edges are scored to help guide the edges as they are folded up. The inserts may be stacked upon one another for easy packaging, shipping, and handling. Ads are placed on the inserts, and the inserts are placed into plastic grocery bags or other carrying containers to reinforce the bottom thereof.

Keane, U.S. Pat. No. (6,908,653), A system for making at least one visual advertisement using at least one stepped surface, comprising: an array of decals displaying one or more visual advertisements on a stepped surface; a plurality of signage substrates wherein the decals are applied to the signage substrates, and; at least one guide mechanism adhered to the stepped surface, wherein each of the signage substrates is positioned by the guide mechanism.

Keach, U.S. Pat. No. (7,124,526), a billboard advertising system is disclosed. The billboard advertising system includes an overhead sign structure at least partially traversing a roadway, said overhead sign structure having forward and rearward faces relative to oncoming vehicle traffic of the roadway. The forward face of the overhead sign structure has traffic information as part of a government regulated traffic information system directed in a primary orientation toward the oncoming vehicle traffic. The rearward face of the overhead sign structure on an opposing side from the forward face has a secondary orientation with respect to other traffic flow different from the oncoming vehicle traffic. A billboard advertisement is positioned on the rearward face of the overhead sign structure with visual exposure to the other traffic flow.

Strzeletz, U.S. Pat. No. (6,598,327), a mobile advertising system including a vehicle and a support structure mounted on the vehicle. The support structure extends substantially from the cab of the vehicle to the rear end of the vehicle and houses at least one light source. At least one translucent display panel is mounted to the support structure so that the light source illuminates the display panel from behind.

Thus, these patents fail to offer a method of advertising, which allows parties to advertise their allegiance to one entity over that of a competitor or rival entity. What is needed is a manner of advertising which allows illustration of the superiority of one entity over another in a novel and entertaining manner.

### BRIEF SUMMARY OF THE INVENTION

The instant invention introduces a novel method of expressing the superiority of one entity over another in a tasteful and humorous manner. Typically, methods of advertising rivals or competitors utilize demeaning slogans or a variation of different pictures of one entity demeaning another entity. However, there is no such invention that uses the method of depicting one entity as a pre-historic monkey transforming through time into another entity.

It is an object of the instant invention to introduce the advertising of an entity by promoting itself and/or its products by cultivating a customer base and cultivating customer loyalty.

Additionally, it is an object of the instant invention to introduce an advertising method that exhibits the advertising entity as a superior life form when compared to the rival or competing entity.

In addition, what is needed is an advertising method which may be utilized by entities such as businesses, organizations, professional sports teams, colleges, high schools, and communities.

The instant invention is broken down into four different figures represented on a particular medium, with the purpose of depicting the evolution of a competing entity into the subject entity for the advertising.

There are additional features of the invention that will be described hereinafter and which will form the subject matter of the claims appended hereto. In this respect, before explaining the embodiment of the invention in detail, it is to be understood that the invention is not limited in its application to the details of construction and to the arrangements of the components set forth in the following description or illustrated in the drawing.

Accordingly, an improved method of advertising and accompanying enhancements its component elements are herein described, which achieve these objectives, plus other advantages and enhancements. These improvements to the art will be apparent from the following description of the invention when considered in conjunction with the accompanying drawings wherein there has thus been outlined, rather broadly, the more important features of the improved method of advertising, in order that the detailed description thereof that follows may be better understood, and in order that the present contribution to the art may be better appreciated.

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE SEVERAL VIEWS OF THE DRAWINGS

FIG. 1 is a demonstration of the method of competitor comparison advertising illustrating the opposing entity being transformed into the entity which is the subject of advertising in a sports application. Also included is the stylized wording of Evolution beneath the transforming entities.

FIG. 2 is a demonstration of the method of competitor comparison advertising illustrating the opposing entity being transformed into the entity which is the subject of advertising in a food and beverage application. Also included is the stylized wording of Evolution beneath the transforming entities.

### DETAILED DESCRIPTION OF THE INVENTION

A method of advertising is described, said method utilizing the evolution of humankind by exhibiting originally a small, playful, and innocuous looking monkey/ape exhibiting some identifying indicia of the opposing party which eventually develops into a larger, intelligent human form, bearing some identifying indicia of the subject party. Thus, the opposing subject of the advertising, be a team, company name, brand name, etc., is represented in some fashion upon the ape portion of evolution and as the ape gains intellect, the ape sheds the representation of the opposing subject and gains reason as a human, finally encompassing a representation of the subject to be advertised. The representations of the subject to be advertised and the opposing subject of the advertising may vary between choice of words, caricatures, emblems, logos, trademarks, or other means or indicia of identification.

Furthermore, said representations may be place upon such items of clothing worn by the subjects, such as shirts, hats, headpieces, helmets, head gear, scarves, wristbands, pants, shorts, socks, jackets or the like. This may be extended to accessories, for instance hand held items capable of depicting the subject and opposing emblem, such as bags, pocketbooks, signage, etc. Thus, the manner and means to achieve the opposing advertising not limited to any one form of expression or even limited to the means disclosed herein. Moreover, the representations of the life forms can be evolutionarily correct or can be illustrated within some reasonable facsimile to the evolutionary scale.

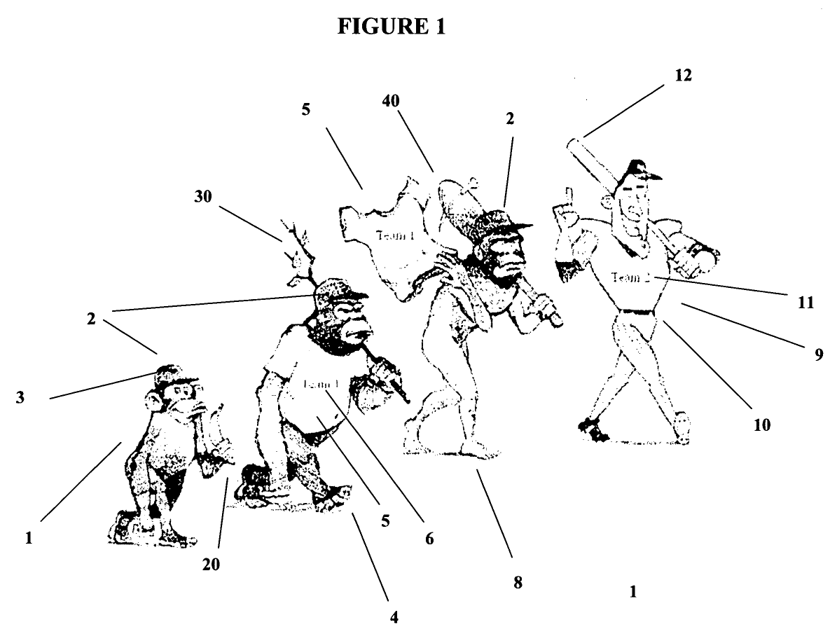

In one embodiment as illustrated in FIG. 1 a sports application, on the lower left of the design space is a depiction of a first early evolutionary, lesser life form, that of a small, playful, happy looking monkey or ape 1. In this embodiment, the monkey/ape 1 dons a hat 2 bearing the name, initials, logo and/or some other identifying indicia of the opposing party 3 in order to identify the opposing entity as a low life form on the evolutionary scale. Additionally, the monkey or ape 1 may carry a banana 20.

Next to the right of, or following in any ascending order is a depiction of a second life form, appearing to be an early evolution era gorilla 4, designed to depict a more advanced stage in the ape-to-human evolution. Said early evolution era gorilla 4, once again dons a hat 2 bearing the name, initials, logo and/or some other identifying indicia of the opposing party 3 and now sports a substantially ragged shirt 5, t-shirt, and/or jacket, upon which is positioned the name, initials, logo and/or some other identifying indicia of the opposing party 6. Additionally, said early evolution era gorilla 4 is not quite erect and is positioned slightly higher than the monkey or ape 1. Moreover, the early evolution era gorilla 4 may carry a branch 30 or some other unsophisticated weapon or tool.

The third figure or life form in the drawing depicts a late evolution era gorilla 8, proximal to the final phase of evolution into a human being. Said late evolution era gorilla 8 once again dons a hat 2 bearing the name, initials, logo and/or some other identifying indicia of the opposing party 3 but here, the late evolution era gorilla 8 is shedding and disposing of the substantially ragged shirt 5, t-shirt, and/or jacket, which clearly displays the identifying indicia of the opposing party 6. Thus, the late evolution era gorilla 8 appears to be revolting against the opposing party. Additionally, said late evolution era gorilla 8 is not quite erect and is positioned slightly higher than the early evolution era gorilla 4. Furthermore, the late evolution era gorilla 8 may carry a wooden club 40 or some other more advanced, but yet still unsophisticated weapon or tool.

The final portrayal depicts a good looking, “idealized” person 9 with a proud, wide smile. Said idealized person 9 is wearing modern clothing or a as depicted here, a full uniform 10 tailored to represent the field of endeavor, sport, activity and/or business of the company and/or product being advertised, with the name, initials, logo and/or some other identifying indicia of the advertising party 11 plainly illustrated on the apparel. As represented here, the idealized person 9 is standing erect, a first arm, here shown as the right arm, may be extended up and slightly forward and may include a fisted hand holding his index finger up in the traditional #1 pose. Herein shown is a baseball player in the above-described stance.

A second arm, herein illustrated as the left arm, may be straight down in a generic pose or as illustrated herein may encompass a hand holding of the product, sport, activity or business being advertised. Herein, the baseball player is holding a baseball bat 12.

An additional feature of this invention is the wording beneath the Figures, which spells out the theme of the advertisement. In large lettering the stylized word Evolution 13 begins just below the monkey and follows the upward movement of the bottom of the four figures. Under the end of the word is a further stylized portion containing the stylized Sports Rivals portion to complete the overall Evolution Sports Rivals™ logo.

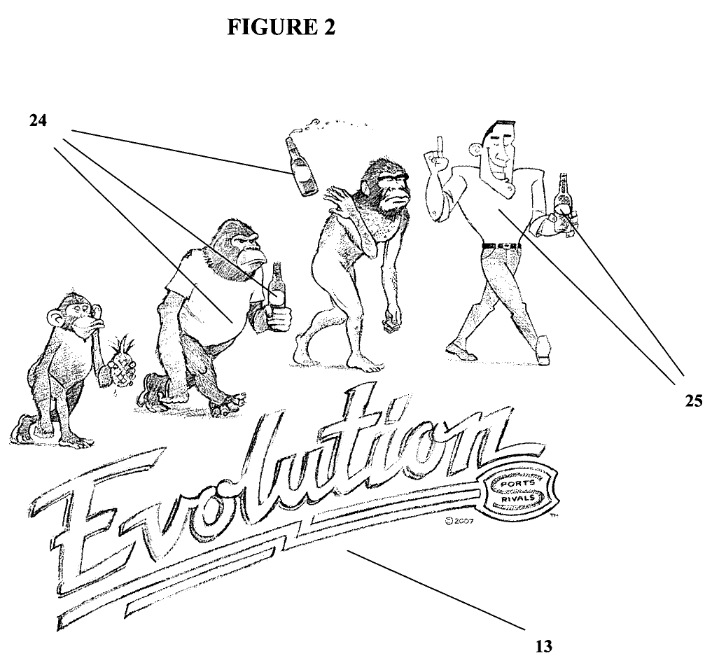

In another embodiment, as illustrated in FIG. 2 differing foods or beverages could be utilized in a similar manner as the above-discussed sports teams. Illustrated also are some areas for placement of a competitors identifying indicia 24 and some suggested areas for placement of identifying indicia of the advertising party 25.

These together with the various features of novelty, which characterize the invention, are pointed out with particularity in the claims annexed to and forming a part of this disclosure. For a better understanding of the invention reference should be made to the accompanying drawings and descriptive matter in which there are illustrated preferred embodiments of the invention.

What is claimed is:

1. A method of advertising comprising the following steps:
utilizing a representation of evolution from ape to mankind;
introducing a subject opposed to a subject to be advertised as a set of inferior evolutionarily developing stages; and
introducing said subject to be advertised as a superior evolutionarily developed being.

2. The method of advertising of claim 1 wherein said set of inferior evolutionarily developing stages are positioned ascending in height within an advertisement according to the evolution of said set of inferior evolutionary developing stages.

3. The method of advertising of claim 2 wherein said superior evolutionarily developed human being is positioned higher within an advertisement than said set of inferior evolutionary developing stages.

4. The method of advertising of claim 1 wherein said set of inferior evolutionarily developing stages further comprises a first lower life form exhibiting an identifying indicia of said subject opposed to a subject to be advertised.

5. The method of advertising of claim 3 wherein said first lower life form further comprises a monkey.

6. The method of advertising of claim 5 wherein said set of inferior evolutionarily developing stages further comprises a second life form, higher on the natural evolutionary scale than said first lower life form, said second life form exhibiting said identifying indicia of said subject opposed to a subject to be advertised.

7. The method of advertising of claim 6 wherein said second life form further comprises an early evolution era gorilla.

8. The method of advertising of claim 7 wherein said set of inferior evolutionarily developing stages further comprises a third life form, higher on the natural evolutionary scale than said second life form and exhibiting said identifying indicia of said subject opposed to a subject to be advertised.

9. The method of advertising of claim 8 wherein said third life form further comprises a late evolution era gorilla.

10. The method of advertising of claim 9 wherein said superior evolutionarily developed being is an idealized human being, exhibiting an identifying indicia of said subject to be advertised.

11. The method of advertising of claim 10 wherein said identifying indicia of said subject opposed to a subject to be advertised is located on an article of clothing.

12. The method of advertising of claim 11 wherein said identifying indicia of said subject to be advertised is located on an article of clothing.

13. The method of advertising of claim 11 wherein said identifying indicia of said article of clothing may be selected from the group consisting of shirts, hats, headpieces, helmets, head gear scarves, wristbands, pants, shorts, socks and jackets.

14. The method of advertising of claim 11 wherein said identifying indicia of said subject opposed to a subject to be advertised may be selected from the group consisting of words, caricatures, emblems, logos and trademarks.

15. The method of advertising of claim 12 wherein said identifying indicia of said subject to be advertised may be selected from the group consisting of words, caricatures, emblems, logos and trademarks.

16. A method of advertising comprising the follow steps:
introducing a first lower life form exhibiting an identifying indicia of a subject opposed to a subject to be advertised upon a hat;
introducing a second life form, higher on the natural evolutionary scale than said first lower life form and exhibiting an identifying indicia of said subject opposed to a subject to be advertised upon a hat and a shirt.
introducing a third life form, higher on the natural evolutionary scale than said second life form and exhibiting an identifying indicia of said subject opposed to a subject to be advertised upon a hat and a shirt.
introducing a superior evolutionarily developed being exhibiting an identifying indicia of a subject to be advertised.

17. The method of advertising of claim 16 wherein said first lower life form further comprises a monkey, wherein said second life form further comprises an early evolution era gorilla, wherein said third life form further comprises a late evolution era gorilla and wherein said superior evolutionarily developed being is a human.

18. The method of advertising of claim 17 wherein said identifying indicia is exhibited on clothing selected from the group consisting of shirts, hats, headpieces, helmets, head gear scarves, wristbands, pants, shorts, socks and jackets.

19. The method of advertising of claim 18 wherein said identifying indicia of said subject opposed to a subject to be advertised may be selected from the group consisting of words, caricatures, emblems, logos and trademarks.

20. The method of advertising of claim 19 wherein said first life form, second life form, third life form and superior evolutionarily developed are positioned ascending in height within an advertisement according to evolution.
